(19) United States
(12) Patent Application Publication
(10) Pub. No.: US 2025/0337517 A1
(43) Pub. Date: Oct. 30, 2025

(54) OPTICAL SIGNAL PROCESSING DEVICE, TAP COEFFICIENT UPDATE METHOD, PROGRAM, AND OPTICAL SIGNAL PROCESSING SYSTEM

(71) Applicant: Nippon Telegraph and Telephone Corporation, Tokyo (JP)

(72) Inventors: Toshiya Matsuda, Musashino-shi, Tokyo (JP); Masahiro Nakagawa, Musashino-shi, Tokyo (JP); Kana Masumoto, Musashino-shi, Tokyo (JP); Kota Nishiyama, Musashino-shi, Tokyo (JP)

(21) Appl. No.: 18/861,234

(22) PCT Filed: May 18, 2022
(86) PCT No.: PCT/JP2022/020723

§ 371 Date: Oct. 29, 2024

(51) Int. Cl. H04J 14/06; G02B 27/28; H04B 10/61; H04B 10/67

(52) U.S. Cl. CPC H04J 14/06; G02B 27/286; H04B 10/614; H04B 10/67

(57) ABSTRACT

An optical signal processing device includes: a polarization separator that separates an input polarization multiplexed signal; an optical coupler that branches one polarization component; an optical coupler that branches another polarization component; optical filters to which the one polarization component branched by the optical coupler is input; optical filters to which the other polarization component branched by the optical coupler is input; an optical coupler that multiplexes outputs of the optical filters; an optical coupler that multiplexes outputs of the optical filters; and a tap coefficient update unit that adaptively sets tap coefficients of the optical filters to separate a polarization multiplexed signal.

### TECHNICAL FIELD

The present invention relates to an optical transmission system. In particular, the present invention relates to an optical signal processing system that separates polarization multiplexed signals by using optical signal processing in transmission and reception of the polarization multiplexed signals.

### BACKGROUND ART

Against the background of rapid traffic growth of data centers, standardization of 100 Gigabit Ethernet (registered trademark) and development of optical modules are in progress. The mainstream of the optical module of 100 Gigabit Ethernet (registered trademark) is constituted by an IM-DD (Intensity modulation-Direct Detection) transceiver of 4 waves×25 Gbit/s, and smaller and power-saving modules such as CFP4 (Centum gigabit Form factor Pluggable 4) and QSFP28 (Quad Form Factor Pluggable 28) are being developed as optical interfaces in a data center.

On the other hand, in order to directly connect data centers, development of an optical module that outputs a desired optical signal of a wavelength division multiplexing (WDM) grid is in progress. For example, small modules such as XFP and SFP+ which are 10 gigabit standards have started to be commercially available, and Non Patent Literature 1 describes the possibility of constructing a low-cost WDM system by using these optical modules.

On the other hand, in the case of a WDM system using an optical signal of 100 gigabits or more, it is common to reduce a baud rate of a signal by using a polarization multiplexed signal in order to alleviate a requirement of electrical characteristics of a receiver. Non Patent Literature 2 describes an optical transceiver transmitting and receiving these polarization multiplexed signals, and performing separation of the polarization multiplexed signals using digital signal processing inside.

### CITATION LIST

### Non Patent Literature

Non Patent Literature 1: Toshiya Matsuda et al., “A study of inter-remote memory direct link with pluggable wavelength tunable optical modules and error-correcting code memories”, IEICE Technical Report Vol. 119, No. 442, BPN2019-54, pp. 7-11, Published: Feb. 24, 2020
Non Patent Literature 2: Kazuro Kikuchi, “Adaptive Equalization Techniques in Digital Coherent Optical Receivers”, IEICE Transactions B, Vol. J96-B, No 3, pp 212-219, Published: Mar. 1, 2013

### SUMMARY OF INVENTION

### Technical Problem

A DSP (Digital Signal Processor) that performs the digital signal processing described above is usually configured by an ASIC (Application Specific Integrated Circuit), but power consumption thereof still occupies a large proportion of the entire optical transceiver. Due to the power consumption of the DSP, it is difficult to downsize an optical transceiver compatible with a polarization multiplexed signal. In addition, in a case where reproduction relay is performed in transmission over a long distance, power consumption of the DSP is added for each relay, leading to an increase in power consumption of the entire system.

Therefore, an object of the present invention is to suppress power consumption of a signal processing device that separates polarization multiplexed signals or a signal processing system using the signal processing device.

### Solution to Problem

In order to solve the above-described problem, an optical signal processing device according to the present invention includes: a polarization separator that separates an input polarization multiplexed signal into two polarization components; a first optical coupler that branches one polarization component separated by the polarization separator; a second optical coupler that branches another polarization component separated by the polarization separator; first and second optical filters to which the one polarization component branched by the first optical coupler is input; third and fourth optical filters to which the other polarization component branched by the second optical coupler is input; a third optical coupler that multiplexes outputs of the first and the third optical filters; a fourth optical coupler that multiplexes outputs of the second and the fourth optical filters; and a tap coefficient update unit that adaptively sets tap coefficients of the first to the fourth optical filters to separate a polarization multiplexed signal.

Other means will be described in Description of Embodiments.

### Advantageous Effects of Invention

According to the present invention, it is possible to suppress power consumption of a signal processing device that separates polarization multiplexed signals or a signal processing system using the signal processing device.

### BRIEF DESCRIPTION OF DRAWINGS

FIG. 1 is a configuration diagram of an optical signal processing device according to an embodiment.

FIG. 2 is a configuration diagram illustrating an optical filter.

FIG. 3 is a configuration diagram of an optical signal processing system according to a first embodiment.

FIG. 4 is a configuration diagram of the optical signal processing system according to a second embodiment.

FIG. 5 is a diagram illustrating operation of each unit of the optical signal processing device.

FIG. 6 is a flowchart of tap coefficient update processing.

FIG. 7 is a graph illustrating power consumption of a comparative example and the present invention.

### DESCRIPTION OF EMBODIMENTS

Hereinafter, embodiments for implementing the present invention will be described in detail with reference to the drawings and mathematical expressions.

### <<Optical Signal Processing Device of Present Embodiment>>

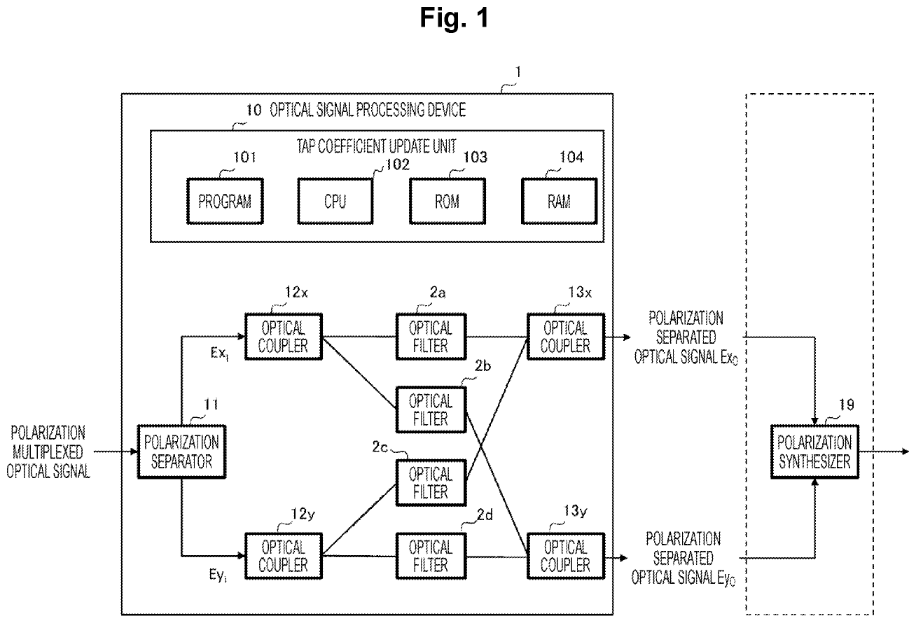

FIG. 1 is a configuration diagram of an optical signal processing device 1 according to an embodiment.

An optical signal processing device 1 includes a tap coefficient update unit 10, a polarization separator 11, optical couplers 12x and 12y, optical filters 2a to 2d, optical couplers 13x and 13y, and a polarization synthesizer 19.

The polarization separator 11 separates an input polarization multiplexed signal into two polarization components.

The optical coupler 12x is a first optical coupler, and branches one polarization component separated by the polarization separator 11. The one polarization component Exᵢ branched by the optical coupler 12x is input to the optical filters 2a and 2b.

The optical coupler 12y is a second optical coupler, and branches the other polarization component separated by the polarization separator 11. The other polarization component Eyᵢ branched by the optical coupler 12y is input to the optical filters 2c and 2d.

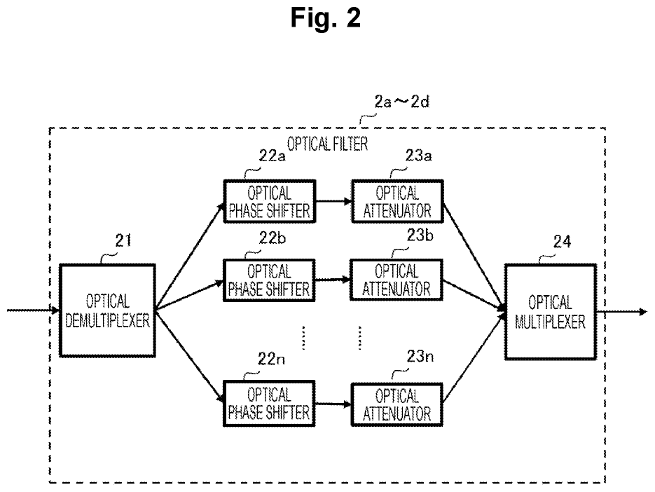

The optical filters 2a to 2d are controlled by the tap coefficient update unit 10 to adjust the attenuation amount of each phase of the input optical signal. The optical filters 2a to 2d correspond to first to fourth optical filters, respectively. Details of the optical filters 2a to 2d will be described later with reference to FIG. 2.

The optical coupler 13x is the third optical coupler, and combines the light output from the optical filters 2a and 2c. A polarization separated optical signal Exₒ is output from the optical coupler 13x.

The optical coupler 13y is the fourth optical coupler, and combines the light output from the optical filters 2b and 2d. A polarization separated optical signal Eyₒ is output from the optical coupler 13y.

The polarization synthesizer 19 synthesizes the polarization separated optical signal Exₒ output from the optical coupler 13x and the polarization separated optical signal Eyₒ output from the optical coupler 13y.

The tap coefficient update unit 10 is a computer including a program 101, a CPU (Central Processing Unit) 102, a ROM (Read Only Memory) 103, and a RAM (Random Access Memory) 104.

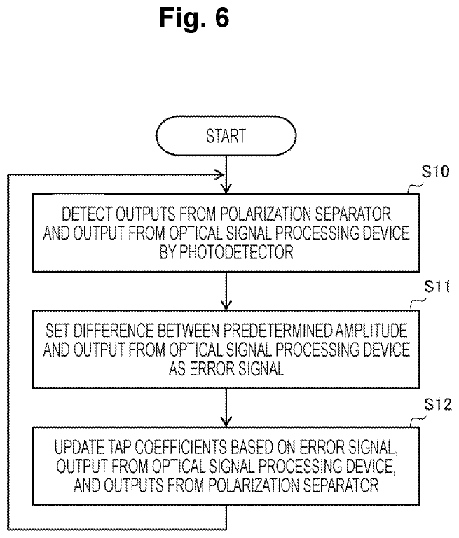

The CPU 102 is a control unit, and executes the program 101 to update control coefficients of the optical filters 2a to 2d. The ROM 103 is a nonvolatile memory and stores data and programs. The RAM 104 is a volatile memory, and stores variables and the like temporarily stored by the program. The program 101 is interpreted and executed by the CPU 102 to execute the processing illustrated in FIG. 6.

The CPU 102 calculates, as an error signal, a difference between a predetermined amplitude and the output signal obtained by multiplexing output signals of the optical filters 2a to 2d. The CPU 102 further calculates tap coefficients of the optical filters 2a to 2d based on the error signal, the output signals of the polarization separator 11, and the output signal obtained by multiplexing the output signals of the optical filters 2a to 2d.

In general, polarization separation by a DSP is performed by updating a tap coefficient hₖ (k=0, . . . , n) of a FIR (Finite Impulse Response) filter connected in a butterfly configuration. The FIR filter is a moving average filter. An output uₒ(t) of the FIR filter is expressed by the following Expression (1) using an input signal uᵢ(t).

$$[ Math . 1 ]$$

$${u}_{o} ( t ) = {h}_{0} {u}_{i} ( t ) + {h}_{1} {u}_{i} ( t - τ ) + … + {h}_{n} {u}_{i} ( t - n τ ) \qquad ( 1 )$$

When Expression (1) is simply configured for an input optical signal, it is necessary to use an optical coupler having a very large number of branches, and a large loss of optical signal power causes signal quality deterioration.

Here, when Expression (1) is Fourier transformed and rewritten in the frequency domain, the following Expression (2) is obtained.

$$[ Math . 2 ]$$

$$\begin{matrix}{U}_{o} ( ω ) = ( {h}_{0} + {h}_{1} {e}^{- i τ ω} + … + {h}_{n} {e}^{- i n τω} ) {U}_{i} ( ω ) \\ \approx {\sum }_{j = - m , … , m} [ {\sum }_{k = ( 1 , … , n} \{ {e}^{( - ik τ ( ω0 + j Δω ) )} \} {U}_{i} ( ω0 + j Δω ) ]\end{matrix} \qquad ( 2 )$$

Here, a center frequency of an optical signal is ω₀, and a sufficiently small frequency interval with respect to the signal band is Δω. The optical signal processing device 1 that separates such polarization multiplexed signals can suppress its own power consumption.

Several algorithms have been proposed that adaptively update the tap coefficient of the FIR filter. For example, similarly to the CMA (Constant Modulus Algorithm) described in Non Patent Literature 2, the tap coefficient update unit 10 updates the tap coefficient according to the following Expression (3).

$$[ Math . 3 ]$$

$$\{ \begin{matrix}H = H + μ \cdot ε \cdot {u}_{o} \cdot {u}_{i}^{*} \\ ε = m - {u}_{o}\end{matrix} \qquad ( 3 )$$

Here, H represents a tap coefficient, μ represents a step size, ε represents an error signal, an asterisk at the upper right of a variable represents a complex conjugate, and m represents an amplitude.

FIG. 2 is a configuration diagram illustrating the optical filters 2a to 2d.

Each of the optical filters 2a to 2d includes an optical demultiplexer 21, a plurality of optical phase shifters 22a to 22n and optical attenuators 23a to 23n, and an optical multiplexer 24.

The optical demultiplexer 21 demultiplexes optical signals in predetermined phase steps (Δω steps). The demultiplexed optical signals are input to the plurality of optical phase shifters 22a to 22n, respectively.

The optical phase shifters 22a to 22n control the phases of respective frequency components. The optical attenuators 23a to 23n control the amplitudes of respective frequency components. The optical multiplexer 24 multiplexes the frequency components. As a result, Expression (2) can be established in the frequency domain.

Here, tap coefficients of the optical attenuators 23a to 23n in the optical filter 2a are F11=(f11₀, f11₁, f11₂, . . . , f11ₙ). Tap coefficients of the optical attenuators 23a to 23n in the optical filter 2b are F12=(f12₀, f12₁, f12₂, . . . , f12ₙ). Tap coefficients of the optical attenuators 23a to 23n in the optical filter 2c are F21=(f21₀, f21₁, f21₂, . . . , f21ₙ). Tap coefficients of the optical attenuators 23a to 23n in the optical filter 2d are F22=(f22₀, f22₁, f22₂, . . . , f22ₙ).

An output of the optical demultiplexer 21 in each optical filter 2 corresponds to U(ω0+jΔω). The attenuation amounts of the optical attenuators 23a to 23n are obtained from the absolute values of the coefficients of the respective frequency components. The phase change amounts of the optical phase shifters 22a to 22n are obtained from the deflection angles of the coefficients of the respective frequency components.

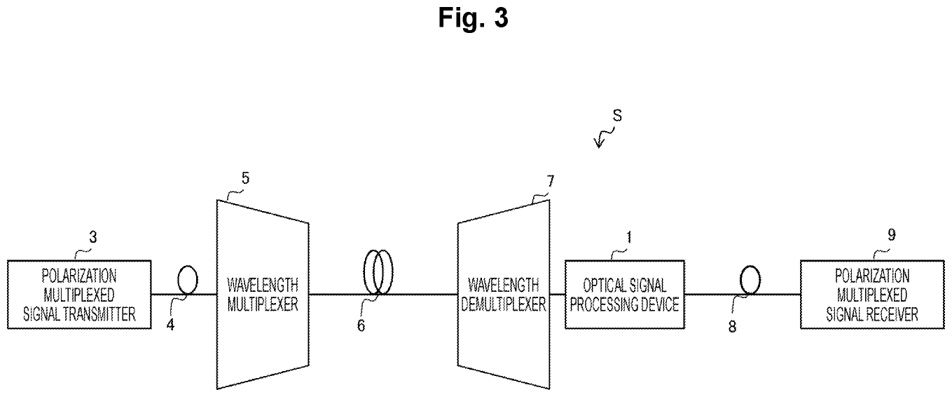

FIG. 3 is a configuration diagram of an optical signal processing system S according to a first embodiment.

The optical signal processing system S includes a polarization multiplexed signal transmitter 3, a wavelength multiplexer 5, a wavelength demultiplexer 7, the optical signal processing device 1, and a polarization multiplexed signal receiver 9.

The polarization multiplexed signal transmitter 3 transmits a polarization multiplexed signal. The polarization multiplexed signal output from the polarization multiplexed signal transmitter 3 is input to the wavelength multiplexer 5 via an optical patch code 4.

The wavelength multiplexer 5 performs wavelength multiplexing on the polarization multiplexed signal. The polarization multiplexed signal wavelength-multiplexed by the wavelength multiplexer 5 is input to the wavelength demultiplexer 7 via an optical transmission line 6.

The wavelength demultiplexer 7 demultiplexes the wavelength multiplexed signal. The wavelength multiplexed signal demultiplexed by the wavelength demultiplexer 7 is input to the optical signal processing device 1.

The optical signal processing device 1 outputs a polarization multiplexed signal of orthogonal linearly polarized lights. The polarization multiplexed signal of the orthogonal linearly polarized lights output from the optical signal processing device 1 is input to the polarization multiplexed signal receiver 9 via a polarization-maintaining optical patch code 8. The polarization-maintaining optical patch code 8 maintains the polarization state of the polarization multiplexed signal. As a result, the optical signal processing system S using the optical signal processing device 1 that separates the polarization multiplexed signal can perform polarization separation without using a DSP, and thus can suppress its own power consumption.

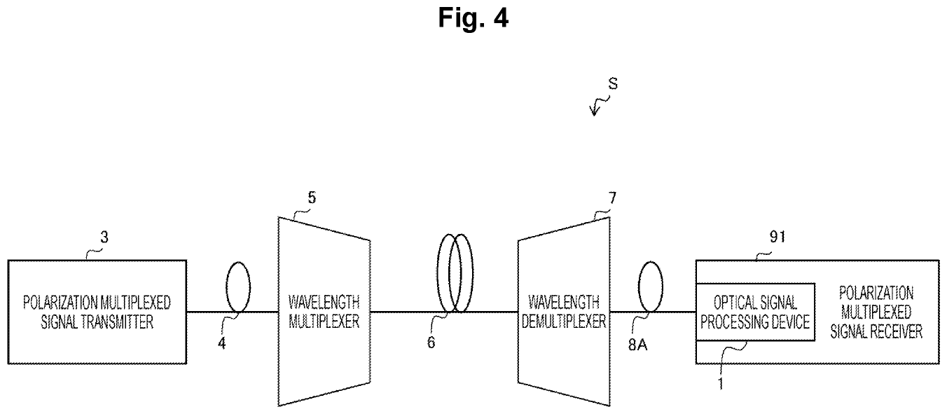

FIG. 4 is a configuration diagram of the optical signal processing system S according to a second embodiment.

The optical signal processing system S includes the polarization multiplexed signal transmitter 3, the wavelength multiplexer 5, the wavelength demultiplexer 7, an optical patch code 8A, and a polarization multiplexed signal receiver 91. The polarization multiplexed signal receiver 91 includes the optical signal processing device 1.

The polarization multiplexed signal transmitter 3 transmits a polarization multiplexed signal. The polarization multiplexed signal output from the polarization multiplexed signal transmitter 3 is input to the wavelength multiplexer 5 via an optical patch code 4.

The wavelength multiplexer 5 performs wavelength multiplexing on the polarization multiplexed signal. The polarization multiplexed signal wavelength-multiplexed by the wavelength multiplexer 5 is input to the wavelength demultiplexer 7 via the optical transmission line 6.

The wavelength demultiplexer 7 demultiplexes the wavelength multiplexed signal. The wavelength multiplexed signal demultiplexed by the wavelength demultiplexer 7 is input to the optical signal processing device 1 included in the polarization multiplexed signal receiver 91.

The optical signal processing device 1 outputs a polarization multiplexed signal of orthogonal linearly polarized lights. The polarization multiplexed signal of the orthogonal linearly polarized lights output from the optical signal processing device 1 is processed by another unit of the polarization multiplexed signal receiver 91. As a result, the optical signal processing system S using the optical signal processing device 1 that separates the polarization multiplexed signal can perform polarization separation without using a DSP, and thus can suppress its own power consumption.

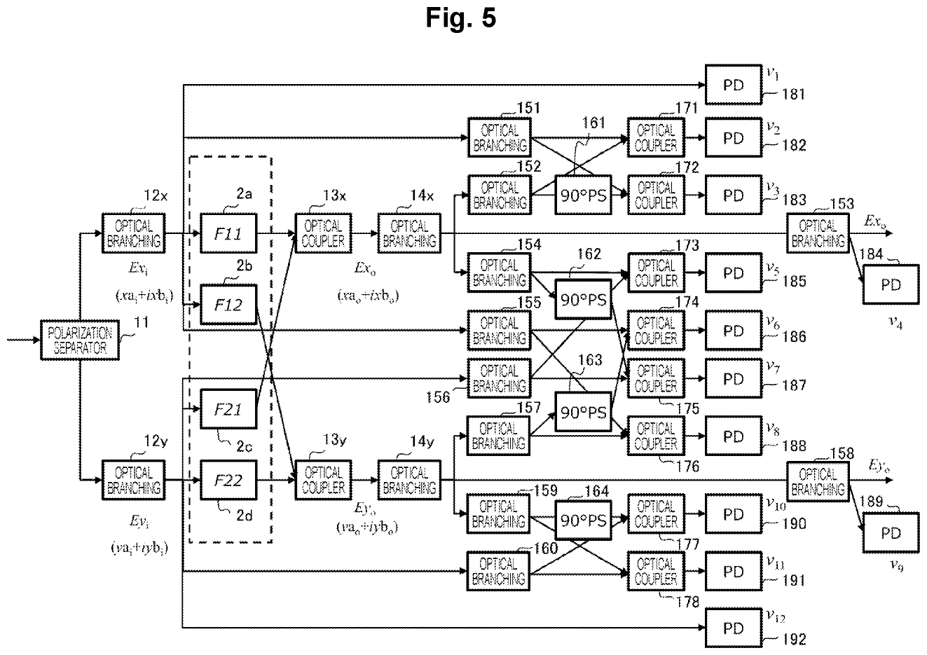

FIG. 5 is a diagram illustrating operation of each unit of the optical signal processing device 1.

The optical signal processing device 1 includes the tap coefficient update unit 10, the polarization separator 11, the optical couplers 12x and 12y, the optical filters 2a to 2d, the optical couplers 13x and 13y, and the polarization synthesizer 19 illustrated in FIG. 1. The optical signal processing device 1 further includes optical couplers 14x and 14y, optical couplers 151 to 160, ¼ wave plates 161 to 164, optical couplers 171 to 178, and photodetectors 181 to 192. The photodetectors 181 to 192 are, for example, photodiodes, and are detectors that detect light. These photodetectors 181 to 192 detect output signals obtained by multiplexing the output signals of the optical filters 2a to 2d connected in a butterfly type. Note that, in the drawings, a photodetector is abbreviated PD (Photo Detector), and each of the ¼ wave plates 161 to 164 is abbreviated as 90° PS. In addition, the optical couplers 12x and 12y, the optical couplers 14x and 14y, and the optical couplers 151 to 160 are referred to as optical branching in the drawings.

The polarization separator 11 separates an input polarization multiplexed signal into two polarization components.

The optical coupler 12x branches the one polarization component separated by the polarization separator 11. The one polarization component is represented by Exᵢ. The polarization component Exᵢ is input to the optical filters 2a and 2b, the photodetector 181, and the optical couplers 151 and 155. The polarization component Exᵢ is expressed by Expression (4)

$$[ Math . 4 ]$$

$${E}_{xi} = {xa}_{i} + {ixb}_{i} \qquad ( 4 )$$

The optical coupler 12y branches the other polarization component separated by the polarization separator 11. The other polarization component is represented by Eyᵢ. The polarization component Eyᵢ is input to the optical filters 2c and 2d, the optical couplers 156 and 160, and the photodetector 192. The polarization component Eyᵢ is expressed by Expression (5)

$$[ Math . 5 ]$$

$${E}_{yi} = {ya}_{i} + {iyb}_{i} \qquad ( 5 )$$

The optical filters 2a to 2d are controlled by the tap coefficient update unit 10 to adjust the attenuation amount of each phase of the input optical signal. The tap coefficient of the optical filter 2a is F11, the tap coefficient of the optical filter 2b is F12, the tap coefficient of the optical filter 2c is F21, and the tap coefficient of the optical filter 2d is F22.

The optical coupler 13x combines the light output from the optical filters 2a and 2c. The polarization separated optical signal Exₒ is output from the optical coupler 13x. The polarization separated optical signal Exₒ is branched by the optical coupler 14x and output to the optical couplers 152 to 154. The polarization separated optical signal Exₒ is expressed by Expression (6).

$$[ Math . 6 ]$$

$${E}_{xo} = {xa}_{o} + {ixb}_{o} \qquad ( 6 )$$

The optical coupler 13y combines the light output from the optical filters 2b and 2d. A polarization separated optical signal Eyₒ is output from the optical coupler 13y. The polarization separated optical signal Eyₒ is branched by the optical coupler 14y and output to the optical couplers 157 to 159. The polarization separated optical signal Eyₒ is expressed by Expression (7)

$$[ Math . 7 ]$$

$${E}_{yo} = {ya}_{o} + {iyb}_{o} \qquad ( 7 )$$

The polarization component Exᵢ output from the optical coupler 12x is input to the optical coupler 151. The signal obtained by branching the polarization component Exᵢ is output from the optical coupler 151 to the optical couplers 171 and 172.

The polarization separated optical signal Exₒ output from the optical coupler 14x is input to the optical coupler 152. The signal obtained by branching the polarization separated optical signal Exₒ is output from the optical coupler 152 to the optical coupler 171 and the ¼ wave plate 161. The signal emitted from the ¼ wave plate 161 is output to the optical coupler 172.

The polarization separated optical signal Exₒ output from the optical coupler 14x is input to the optical coupler 153. The signal obtained by branching the polarization separated optical signal Exₒ is output from the optical coupler 153 to the photodetector 184 and the polarization synthesizer 19 in FIG. 1.

The polarization separated optical signal Exₒ output from the optical coupler 14x is input to the optical coupler 154. The signal obtained by branching the polarization separated optical signal Exₒ is output from the optical coupler 154 to the optical coupler 173 and the ¼ wave plate 162. The signal emitted from the ¼ wave plate 162 is output to the optical coupler 175.

The polarization component Exᵢ output from the optical coupler 12x is input to the optical coupler 155. The signal obtained by branching the polarization component Exᵢ is output from the optical coupler 155 to the optical couplers 174 and 176.

The polarization component Eyᵢ output from the optical coupler 12y is input to the optical coupler 156. The signal obtained by branching the polarization component Eyᵢ is output from the optical coupler 156 to the optical couplers 173 and 175.

The polarization separated optical signal Eyₒ output from the optical coupler 14y is input to the optical coupler 157. The signal obtained by branching the polarization separated optical signal Eyₒ is output from the optical coupler 157 to the ¼ wave plate 163 and the optical coupler 176. The signal emitted from the ¼ wave plate 163 is output to the optical coupler 174.

The polarization separated optical signal Eyₒ output from the optical coupler 14y is input to the optical coupler 158. The signal obtained by branching the polarization separated optical signal Eyₒ is output from the optical coupler 158 to the photodetector 189 and the polarization synthesizer 19 in FIG. 1.

The polarization separated optical signal Eyₒ output from the optical coupler 14y is input to the optical coupler 159. The signal obtained by branching the polarization separated optical signal Eyₒ is output from the optical coupler 159 to the ¼ wave plate 164 and the optical coupler 178. The signal emitted from the ¼ wave plate 164 is output to the optical coupler 177.

The polarization component Eyᵢ output from the optical coupler 12y is input to the optical coupler 160. The signal obtained by branching the polarization component Eyᵢ is output from the optical coupler 160 to the optical couplers 177 and 178.

The polarization component Exᵢ output from the optical coupler 151 and the polarization separated optical signal Exₒ output from the optical coupler 152 are input to the optical coupler 171. The signal obtained by multiplexing the polarization components Exᵢ and Exₒ is output to the photodetector 182.

The polarization component Exᵢ output from the optical coupler 151 and the polarization separated optical signal Exₒ⁺ emitted from the ¼ wave plate 161 are input to the optical coupler 172. The signal obtained by multiplexing the polarization components Eyᵢ and Exₒ⁺ is output to the photodetector 183.

The polarization component Exᵢ output from the optical coupler 154 and the polarization component Eyᵢ output from the optical coupler 156 are input to the optical coupler 173. The signal obtained by multiplexing the polarization components Exᵢ and Eyᵢ is output to the photodetector 185.

The polarization component Exᵢ output from the optical coupler 155 and the polarization separated optical signal Eyₒ⁺ emitted from the ¼ wave plate 163 are input to the optical coupler 174. The signal obtained by multiplexing the polarization components Exᵢ and Eyₒ⁺ is output to the photodetector 186.

The polarization separated optical signal Exₒ⁺ emitted from the ¼ wave plate 162 and the polarization component Eyᵢ output from the optical coupler 156 are input to the optical coupler 175. The signal obtained by multiplexing the polarization components Eyᵢ and Exₒ⁺ is output to the photodetector 187.

The polarization component Exᵢ output from the optical coupler 155 and the polarization separated optical signal Eyₒ output from the optical coupler 157 are input to the optical coupler 176. The signal obtained by multiplexing the polarization components Exᵢ and Eyₒ is output to the photodetector 188.

The polarization separated optical signal Eyₒ⁺ emitted from the ¼ wave plate 164 and the polarization component Eyᵢ output from the optical coupler 160 are input to the optical coupler 177. The signal obtained by multiplexing the polarization components Eyᵢ and Eyₒ⁺ is output to the photodetector 190.

The polarization component Exᵢ output from the optical coupler 151 and the polarization separated optical signal Exₒ output from the optical coupler 152 are input to the optical coupler 178. The signal obtained by multiplexing the polarization components Exᵢ and Exₒ is output to the photodetector 191.

Output powers of the optical couplers 12x and 12y are adjusted to be equal to each other, and input powers to the photodetectors 181 to 182 are adjusted to be equal to each other. Since the photodetector 181 performs square detection when the coefficient is omitted, a detection output v₁ thereof is expressed by Expression (8)

$$[ Math . 8 ]$$

$${v}_{1} = {\vert {xa}_{i} + {ixb}_{i} \vert}^{2} \qquad ( 8 )$$

A detection output v₂ of the photodetector 182 is expressed by Expression (9).

$$[ Math . 9 ]$$

$${v}_{2} = {\vert {xa}_{i} + i x {b}_{i} + x {a}_{o} + {ixb}_{o} \vert}^{2} \qquad ( 9 )$$

A detection output v₃ of the photodetector 183 is expressed by Expression (10).

$$[ Math . 10 ]$$

$${v}_{3} = {\vert {xa}_{i} + i x {b}_{i} - x {b}_{o} + {ixa}_{o} \vert}^{2} \qquad ( 10 )$$

A detection output v₄ of the photodetector 184 is expressed by Expression (11).

$$[ Math . 11 ]$$

$${v}_{4} = {\vert {xa}_{o} + ix {b}_{o} \vert}^{2} \qquad ( 11 )$$

A detection output v₅ of the photodetector 185 is expressed by Expression (12).

$$[ Math . 12 ]$$

$${v}_{5} = {\vert {ya}_{i} + i {yb}_{i} + {xa}_{o} + i x {b}_{o} \vert}^{2} \qquad ( 12 )$$

A detection output v₆ of the photodetector 186 is expressed by Expression (13).

$$[ Math . 13 ]$$

$${v}_{6} = {\vert {xa}_{i} + {ixb}_{i} - {yb}_{o} + {iya}_{o} \vert}^{2} \qquad ( 13 )$$

A detection output v₇ of the photodetector 187 is expressed by Expression (14).

$$[ Math . 14 ]$$

$${v}_{7} = {\vert {ya}_{i} + {iyb}_{i} - {xb}_{o} + {ixa}_{o} \vert}^{2} \qquad ( 14 )$$

A detection output v₈ of the photodetector 188 is expressed by Expression (15).

$$[ Math . 15 ]$$

$${v}_{8} = {\vert {xa}_{i} + {ixb}_{i} + {ya}_{o} + {iyb}_{o} \vert}^{2} \qquad ( 15 )$$

A detection output v₉ of the photodetector 189 is expressed by Expression (16).

$$[ Math . 16 ]$$

$${v}_{9} = \vert {ya}_{o} + {iyb}_{o} \vert \qquad ( 16 )$$

A detection output v₁₀ of the photodetector 190 is expressed by Expression (17).

$$[ Math . 17 ]$$

$${v}_{10} = {\vert {ya}_{i} + i y x {b}_{i} - {yb}_{o} + {iya}_{o} \vert}^{2}$$

A detection output v₁₁ of the photodetector 191 is expressed by Expression (18).

$$[ Math . 18 ]$$

$${v}_{11} = {\vert {ya}_{i} + {iyb}_{i} + {ya}_{o} + {jyb}_{o} \vert}^{2} \qquad ( 18 )$$

A detection output v₁₂ of the photodetector 192 is expressed by Expression (19).

$$[ Math . 19 ]$$

$${v}_{12} = {\vert {ya}_{i} + {iyb}_{i} \vert}^{2} \qquad ( 19 )$$

At this time, Exᵢ·Exₒ⁺ can be calculated by Expression (20) using v₁ to v₄.

$$[ Math . 20 ]$$

$$\begin{matrix}( {v}_{1} - {v}_{2} - {v}_{4} ) + i ( {v}_{3} - {v}_{1} - {v}_{4} ) = ( 2 x {a}_{i} x {a}_{o} + 2 x {b}_{i} x {b}_{o} ) - \\ i ( 2 x {a}_{i} {xa}_{o} - 2 x {b}_{i} {xb}_{o} ) \\ = 2 ( {xa}_{i} + {ixb}_{i} ) ( x {a}_{o} - {ixb}_{o} ) \\ = 2 {Ex}_{i} \cdot {Ex}_{o}^{*}\end{matrix} \qquad ( 20 )$$

Eyᵢ·Exₒ⁺ can be calculated by Expression (21). [Math. 21]

$$[ Math . 21 ]$$

$$\begin{matrix}( {v}_{5} - {v}_{4} - {v}_{12} ) + i ( {v}_{7} - {v}_{4} - {v}_{12} ) = ( 2 {ya}_{i} x {a}_{o} + 2 {yb}_{i} x {b}_{o} ) - \\ i ( 2 x {a}_{i} {xa}_{o} - {xb}_{i} {xb}_{o} ) \\ = 2 ( {ya}_{i} + {iyb}_{i} ) ( x {a}_{o} - {ixb}_{o} ) \\ = 2 {Ey}_{i} \cdot {Ex}_{o}^{*}\end{matrix} \qquad ( 21 )$$

Exᵢ·Eyₒ⁺ can be calculated by Expression (22).

$$[ Math . 22 ]$$

$$\begin{matrix}( {v}_{8} - {v}_{1} - {v}_{9} ) + i ( {v}_{6} - {v}_{9} - {v}_{1} ) = ( 2 {ya}_{i} x {a}_{o} + 2 {yb}_{i} x {b}_{o} ) - \\ i ( {xa}_{i} {xa}_{o} - {xb}_{i} {xb}_{o} ) \\ = 2 ( {ya}_{i} + {iyb}_{i} ) ( x {a}_{o} - {ixb}_{o} ) \\ = 2 {Ex}_{i} \cdot {Ey}_{o}^{*}\end{matrix} \qquad ( 22 )$$

Eyᵢ·Eyₒ⁺ can be calculated by Expression (23).

$$[ Math . 23 ]$$

$$\begin{matrix}( {v}_{12} - {v}_{11} - {v}_{9} ) + i ( {v}_{10} - {v}_{12} - {v}_{9} ) = ( 2 {ya}_{i} {ya}_{o} + 2 {yb}_{i} {yb}_{o} ) - \\ i ( 2 {ya}_{i} {ya}_{o} - 2 {yb}_{i} {yb}_{o} ) \\ = 2 ( {ya}_{i} + {iyb}_{i} ) ( {ya}_{o} - {iyb}_{o} ) \\ = 2 {Ey}_{i} \cdot {Ey}_{o}^{*}\end{matrix} \qquad ( 23 )$$

Then, the coefficient of F11 can be updated on the basis of Exᵢ·Exₒ⁺ by using Expression (3). F11=(f11₀, f11₁, . . . , f11ₙ) corresponds to (h₀, h₁, . . . , hₙ) in Expression (1).

The coefficient of F12 can be updated on the basis of Eyᵢ·Exₒ⁺ by using Expression (3). F12=(f12₀, f12₁, . . . f12ₙ) corresponds to (h₀, h₁, . . . , hₙ) in Expression (1).

The coefficient of F21 can be updated on the basis of Exᵢ·Eyₒ⁺ by using Expression (3). F21=(f21₀, f21₁, . . . , f21ₙ) corresponds to (h₀, h₁, . . . , hₙ) in Expression (1). The coefficient of F22 can be updated on the basis of Eyᵢ·Eyₒ⁺ by using Expression (3). F22=(f22₀, f22₁, . . . , f22ₙ) corresponds to (h₀, h₁, . . . , hₙ) in Expression (1).

FIG. 6 is a flowchart of tap coefficient update processing.

The CPU 102 detects outputs from the polarization separator 11 and an output from the optical signal processing device 1 by a photodetector (step S10).

Next, the CPU 102 sets a difference between a predetermined amplitude m and the output from the optical signal processing device 1 as an error signal ε (step S11).

When the CPU 102 updates the tap coefficients on the basis of the error signal ε, the output from the optical signal processing device 1, and the outputs from the polarization separator 11 (step S12), the process returns to step S10 and is repeated.

Power consumption of an optical signal processing circuit that separates a polarization multiplexed signal using the present invention is evaluated. In general, power consumption of an optical device is much smaller than that of an electric circuit. In an example of a variable wavelength dispersion compensator having the same configuration as the optical filter in the present invention, the power consumption is 0.24 W, and the power consumption of the present invention including the four optical filters can be estimated to be 0.96 W. It is assumed that the power consumption of the photodetector and the control circuit is negligibly small.

On the other hand, in a comparative example related to the power consumption of a DSP that separates a polarization multiplexed signal, which is a prior art, the power consumption is 0.1 W/Gbps, which depends on the signal bit rate.

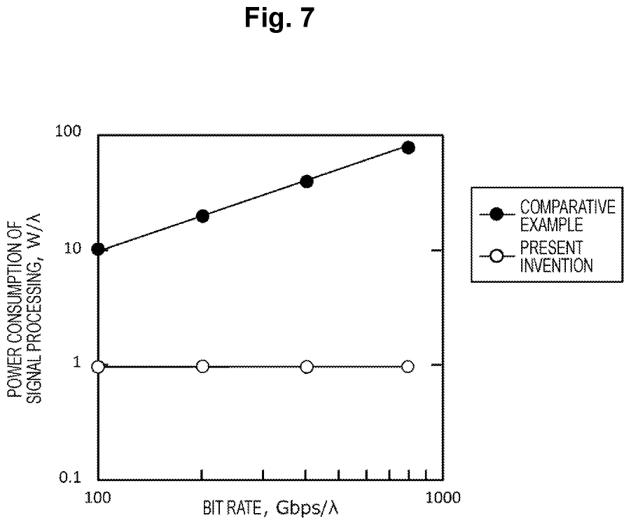

FIG. 7 is a graph illustrating power consumption of the comparative example and the present invention.

The power consumption of the comparative example increases as the bit rate increases, whereas the power consumption of the present invention maintains a predetermined value regardless of the bit rate. For example, when compared in a case where the bit rate is 800 Gbps, the power consumption can be suppressed to about 1/100 in the present invention as compared with the prior art.

As described above, by using the present invention, power consumption of a signal processing circuit that separates a polarization multiplexed signal can be greatly suppressed, and the size of an optical module that can transmit and receive the polarization multiplexed signal can be reduced.

### Effects

Hereinafter, effects of the optical signal processing device and the like according to the present invention will be described.

### <<Claim 1>>

An optical signal processing device comprising:
a polarization separator that separates an input polarization multiplexed signal into two polarization components;
a first optical coupler that branches one polarization component separated by the polarization separator;
a second optical coupler that branches another polarization component separated by the polarization separator;
first and second optical filters to which the one polarization component branched by the first optical coupler is input;
third and fourth optical filters to which the other polarization component branched by the second optical coupler is input;
a third optical coupler that multiplexes outputs of the first and the third optical filters;
a fourth optical coupler that multiplexes outputs of the second and the fourth optical filters; and
a tap coefficient update unit that adaptively sets tap coefficients of the first to the fourth optical filters to separate a polarization multiplexed signal.

With this configuration, it is possible to suppress power consumption of the signal processing device that separates a polarization multiplexed signal. Furthermore, the first to the fourth optical filters can be connected in a butterfly type.

### <<Claim 2>>

The optical signal processing device according to claim 1, wherein
each of the first to the fourth optical filters includes:
an optical demultiplexer that demultiplexes an optical signal at predetermined phase intervals;
a plurality of optical phase shifters that control phases of respective frequency components of optical signals demultiplexed by the optical demultiplexer;
a plurality of optical attenuators that control amplitudes of respective optical signals with the phases controlled by the respective optical phase shifters; and
an optical multiplexer that multiplexes optical signals output from the plurality of optical attenuators.

With this configuration, the tap coefficients of the optical filters connected in the butterfly type can be set.

### <<Claim 3>>

The optical signal processing device according to claim 1, wherein
the tap coefficient update unit adaptively sets coefficients of the first to the fourth optical filters so as to output a signal obtained by applying a moving average filter to the input polarization multiplexed signal.

With this configuration, it is possible to implement a moving average filter using an optical filter without using a DSP.

### <<Claim 4>>

A tap coefficient update method comprising:
a step of detecting, by a detector, an output signal of a polarization separator that separates an input polarization multiplexed signal into two polarization components;
a step of detecting, by the detector, an output signal obtained by multiplexing output signals of optical filters connected to the polarization separator in a butterfly type;
a step of calculating, by a control unit, as an error signal, a difference between a predetermined amplitude and an output signal obtained by multiplexing the output signals of the optical filters; and
a step of calculating, by the control unit, tap coefficients of the optical filters based on the error signal, the output signal of the polarization separator, and the output signal obtained by multiplexing the output signals of the optical filters.

With this configuration, it is possible to separate a polarization multiplexed signal while suppressing power consumption.

### <<Claim 5>>

A program that causes a computer to perform:
a process of detecting an output signal of a polarization separator that separates an input polarization multiplexed signal into two polarization components;
a process of detecting an output signal obtained by multiplexing output signals of optical filters connected to the polarization separator in a butterfly type;
a process of calculating, as an error signal, a difference between a predetermined amplitude and an output signal obtained by multiplexing the output signals of the optical filters; and
a process of calculating tap coefficients of the optical filters based on the error signal, the output signal of the polarization separator, and the output signal obtained by multiplexing the output signals of the optical filters.

With this configuration, it is possible to separate a polarization multiplexed signal while suppressing power consumption.

### <<Claim 6>>

An optical signal processing system comprising:
a polarization multiplexed signal transmitter that transmits a polarization multiplexed signal;
a wavelength multiplexer that is connected by an optical patch code and performs wavelength multiplexing on the polarization multiplexed signal;
a wavelength demultiplexer that is connected to the wavelength multiplexer by an optical transmission line and demultiplexes a signal wavelength-multiplexed by the wavelength multiplexer;
the optical signal processing device according to claim 1, the optical signal processing device being configured to polarization-separate the polarization multiplexed signal demultiplexed by the wavelength demultiplexer, and then output a polarization multiplexed signal of orthogonal linearly polarized lights; and
a polarization multiplexed signal receiver that is connected by a polarization-maintaining optical patch code that maintains a polarization state of the polarization multiplexed signal output from the optical signal processing device.

With this configuration, it is possible to suppress power consumption of the signal processing system using the signal processing device that separates a polarization multiplexed signal.

### <<Claim 7>>

An optical signal processing system comprising:
a polarization multiplexed signal transmitter that transmits a polarization multiplexed signal;
a wavelength multiplexer that is connected by an optical patch code and performs wavelength multiplexing on the polarization multiplexed signal;
a wavelength demultiplexer that is connected to the wavelength multiplexer by an optical transmission line and demultiplexes a wavelength multiplexed signal; and
a polarization multiplexed signal receiver that is connected to the wavelength demultiplexer by an optical patch code, and includes the optical signal processing device according to claim 1, the optical signal processing device being configured to polarization-separate the polarization multiplexed signal demultiplexed by the wavelength demultiplexer.

With this configuration, it is possible to suppress power consumption of the signal processing system using the signal processing device that separates a polarization multiplexed signal.

### REFERENCE SIGNS LIST

1 Optical signal processing device
10 Tap coefficient update unit
101 Program
102 CPU
103 ROM
104 RAM
11 Polarization separator
12x Optical coupler (first optical coupler)
12y Optical coupler (second optical coupler)
13x Optical coupler (third optical coupler)
13y Optical coupler (fourth optical coupler)
14x, 14y Optical coupler
151 to 160 Optical coupler
161 to 164 ¼ wave plate
171 to 178 Optical coupler
181 to 191 Photodetector (detector)
19 Polarization synthesizer
2a Optical filter (first optical filter)
2b Optical filter (second optical filter)
2c Optical filter (third optical filter)
2d Optical filter (fourth optical filter)
21 Optical demultiplexer
22a to 22n Optical phase shifter
23a to 23n Optical attenuator
24 Optical multiplexer
3 Polarization multiplexed signal transmitter
4 Optical patch code
5 Wavelength multiplexer
6 Optical transmission line
7 Wavelength demultiplexer
8, 8A Polarization-maintaining optical patch code
9, 91 Polarization multiplexed signal receiver

1. An optical signal processing device comprising:
a polarization separator configured to separate an input polarization multiplexed signal into two polarization components;
a first optical coupler configured to branch one polarization component separated by the polarization separator;
a second optical coupler configured to branch another polarization component separated by the polarization separator;
first and second optical filters to which the one polarization component branched by the first optical coupler is input;
third and fourth optical filters to which the other polarization component branched by the second optical coupler is input;
a third optical coupler configured to multiplex outputs of the first and the third optical filters;
a fourth optical coupler configured to multiplex outputs of the second and the fourth optical filters; and
a tap coefficient update unit configured to adaptively set tap coefficients of the first to the fourth optical filters to separate a polarization multiplexed signal.

2. The optical signal processing device according to claim 1, wherein each of the first to the fourth optical filters includes:
an optical demultiplexer configured to demultiplex an optical signal at predetermined phase intervals;
a plurality of optical phase shifters configured to control phases of respective frequency components of optical signals demultiplexed by the optical demultiplexer;
a plurality of optical attenuators configured to control amplitudes of respective optical signals with the phases controlled by the respective optical phase shifters; and
an optical multiplexer configured to multiplex optical signals output from the plurality of optical attenuators.

3. The optical signal processing device according to claim 1, wherein
the tap coefficient update unit is configured to adaptively set coefficients of the first to the fourth optical filters so as to output a signal obtained by applying a moving average filter to the input polarization multiplexed signal.

4. A tap coefficient update method comprising:
detecting, by a detector, an output signal of a polarization separator that separates an input polarization multiplexed signal into two polarization components;
detecting, by the detector, an output signal obtained by multiplexing output signals of optical filters connected to the polarization separator in a butterfly type;
calculating, by a control unit, as an error signal, a difference between a predetermined amplitude and an output signal obtained by multiplexing the output signals of the optical filters; and
calculating, by the control unit, tap coefficients of the optical filters based on the error signal, the output signal of the polarization separator, and the output signal obtained by multiplexing the output signals of the optical filters.

5. A non-transitory computer readable medium storing a program that causes a computer to perform operations comprising:
detecting an output signal of a polarization separator that separates an input polarization multiplexed signal into two polarization components;
detecting an output signal obtained by multiplexing output signals of optical filters connected to the polarization separator in a butterfly type;
calculating, as an error signal, a difference between a predetermined amplitude and an output signal obtained by multiplexing the output signals of the optical filters; and
calculating tap coefficients of the optical filters based on the error signal, the output signal of the polarization separator, and the output signal obtained by multiplexing the output signals of the optical filters.

6. (canceled)

7. (canceled)
